(19) United States
(12) Patent Application Publication
(10) Pub. No.: US 2006/0091171 A1
(43) Pub. Date: May 4, 2006

(54) Tailgate tire carrier

(76) Inventors: Kenneth Lee Wardell, Monroe, MI (US); Salvatore Bitonti, Warren, MI (US); Derek Robert Tuttle, Luna Pier, MI (US)

Correspondence Address: CLARK HILL, P.C., 500 WOODWARD AVENUE, SUITE 3500, DETROIT, MI, 48226, US

(21) Appl. No.: 11/263,459

(22) Filed: Oct. 31, 2005

Related U.S. Application Data
(60) Provisional application No. 60/623,254, filed on Oct. 29, 2004.

(51) Int. Cl. B60R 9/00; B62D 43/00

(52) U.S. Cl. 224/504; 224/508; 224/42.21

(57) ABSTRACT

A tailgate assembly is disposed between spaced apart first and second sides of a truck bed for retaining a tire. The tailgate assembly includes a cross member extending between and pivotally secured to the first and second side members to create a barrier for the truck bed. The tailgate assembly also includes a carrier extending out from the cross member for retaining the tire over a portion of the truck bed.

### CROSS-REFERENCE TO RELATED APPLICATION

This application claims priority to and the benefit of U.S. Provisional Application Ser. No. 60/623,254, filed on Oct. 29, 2004 and entitled “Tailgate Tire Carrier.”

### FIELD OF THE INVENTION

The invention relates to a tailgate assembly for a pickup truck. More particularly, this invention relates to a pickup truck tailgate assembly having a carrier for securing a tire thereto.

### DESCRIPTION OF RELATED ART

Pickup trucks include a truck bed defined by a passenger cab, a pair of spaced apart sidewalls extending out rearwards from the passenger cab, and a tailgate extending between the pair of spaced apart sidewalls. The truck bed is primarily utilized for the storage and transport of cargo. For this reason, it is essential that as much space within the truck bed as possible remains available for cargo storage.

An important consideration in pickup trucks is the placement of an alternate wheel and tire combination, commonly referred to as a spare tire. This consideration is complicated by the fact that spare tires for pickup trucks need to support substantial payloads and are, therefore, large and heavy. Typically, a spare tire is either mounted inside the truck bed or directly underneath the truck bed. Mounting the spare tire inside the truck bed results, however, in a considerable reduction in the amount of available storage space within the truck bed, which is undesirable for many users. Further, in order to access the spare tire inside the truck bed, users must first climb into the truck bed and then transfer the large and heavy spare tire to the ground. For many users, this is an arduous task.

And while mounting the spare tire underneath the truck bed does not reduce the amount of available storage space within the truck bed, accessing the spare tire underneath the truck bed can be problematic. Specifically, users must slide underneath the truck bed in order to remove the spare tire. This may be difficult in light of the specific road and weather conditions existing at the time the spare tire is needed. Once the spare tire is lowered, it must be pulled out from under the truck bed. Thus, many users have a difficult time accessing the spare tire underneath the truck bed of the pickup truck.

### SUMMARY OF THE INVENTION

According to one aspect of the invention, a tailgate assembly is disposed between spaced apart first and second sides of a truck bed for retaining a tire. The tailgate assembly includes a cross member extending between and pivotally secured to the first and second sides of the truck bed to create a barrier for the truck bed. The tailgate assembly also includes a carrier extending out from the cross member for retaining the tire over a portion of the truck bed.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a rear, perspective view of a pickup truck including a tailgate assembly according to the invention having a carrier;

FIG. 2 is a fragmentary, perspective view of the pickup truck including the tailgate assembly;

FIG. 3 is a perspective view of the tailgate assembly including the carrier;

FIG. 4 is a rear, perspective view of the pickup truck including a tire secured to the carrier;

FIG. 5 is a fragmentary, perspective view of the pickup truck including the tire secured to the carrier while the tailgate assembly is in a closed position;

FIG. 6 is a fragmentary, perspective view of the pickup truck including the tire secured to the carrier while the tailgate assembly is in an open position; and

FIG. 7 is a fragmentary, front perspective view of a truck bed of the pickup truck including the tire secured to the carrier while the tailgate assembly is in the open position.

### DETAILED DESCRIPTION OF THE PREFERRED EMBODIMENT

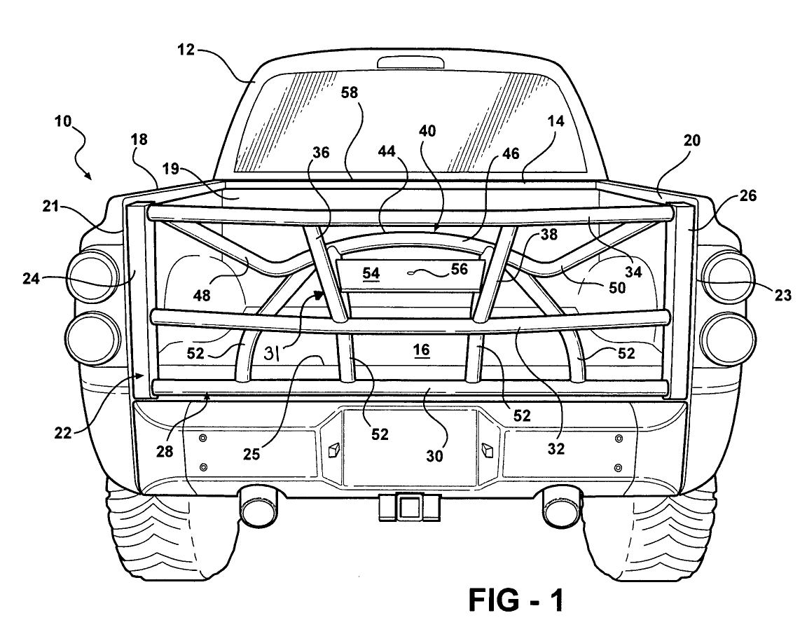

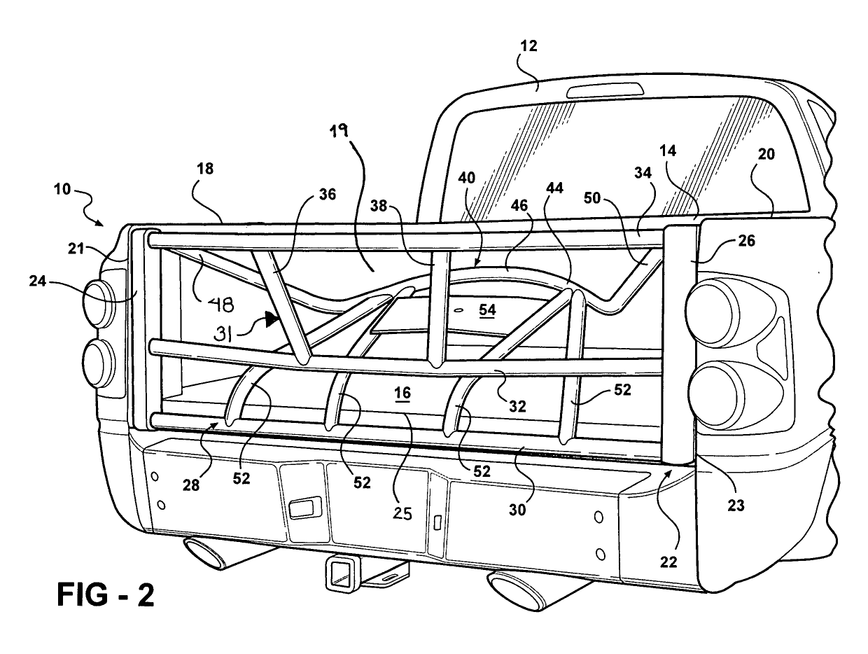

Referring to FIGS. 1 and 2, a pickup truck, generally shown at 10, includes a passenger cab 12 defining a back wall 14. The pickup truck 10 also includes a truck bed 16 designed to carry a payload, as is well known in the art. Two longitudinal sides 18, 20 extend upwardly from the truck bed 16 and, together with the back wall 14, form a box 19 behind the passenger cab 12. A tailgate assembly, generally indicated at 22, is extendable between the two sides 18, 20 at distal ends 21, 23 thereof to prevent payload from falling off a back edge 25 of the truck bed 16, while allowing the loading of the payload onto the truck bed 16 without lifting the payload over the sides 18, 20.

Referring to FIGS. 1 through 3, the tailgate assembly 22 includes laterally spaced apart first 24 and second 26 side members. The first side member 24 is disposed adjacent to and is pivotally secured to the first side 18 of the pickup truck 10, and the second side member 26 is disposed adjacent to and is pivotally secured to the second side 20 of the pickup truck 10. The first 24 and second 26 side members are pivotally secured to the respective first 18 and second 20 sides of the pickup truck 10 by conventional hinge mechanisms (not shown), as are known to those of ordinary skill in the art.

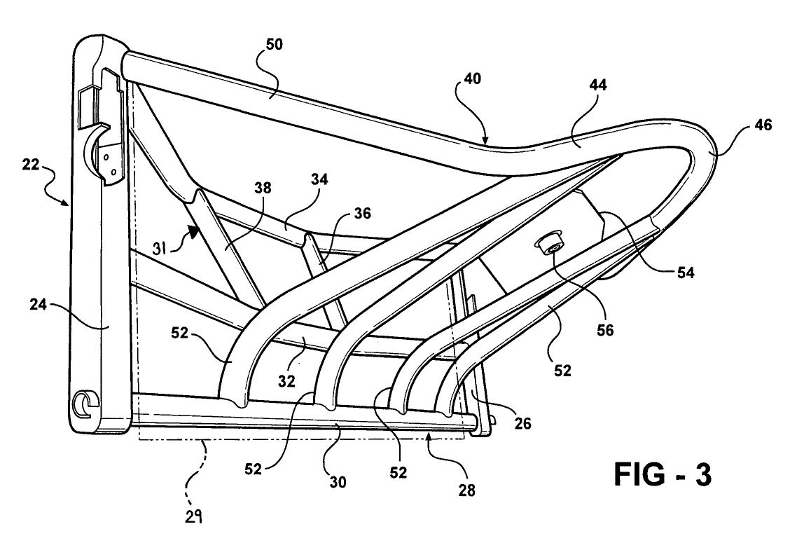

The tailgate assembly 22 also includes a cross member, generally indicated at 28, extending laterally between the first 24 and second 26 side members. The cross member 28 acts as a barrier at the back edge 25 of the truck bed 16. The cross member 28 includes a bottom member 30 fixedly secured to and extending laterally between the first 24 and second 26 side members. The first 24 and second 26 side members, and the bottom member 30 all extend within a plane 29, as shown in FIG. 3.

The cross member 28 also includes a tire support, generally indicated at 31, having a pair of support members 32, 34 each fixedly secured to and extending laterally between the first 24 and second 26 side members. The tire support 31 also includes a pair of loading members 36, 38 extending between the pair of support members 32, 34. In a preferred embodiment, each of the support members 32, 34 and loading members 36, 38 define a curved plane that extends outside the truck bed 16 and out of the plane 29. Although the support 32, 34 and loading 36, 38 members extend out of the plane 29 in the preferred embodiment, it is contemplated that the entire cross member 28, that is, the bottom member 30, the support members 32, 34, and the loading members 36, 38 may extend within the same plane 29 in an alternative embodiment.

In addition, although the tire support 31 has been shown and described as having two support members 32, 34 and two loading members 36, 38, it is appreciated that the exact number of support and loading members in the tire support 31 may vary. It is further appreciated that although the cross member 28 has been shown and described as a plurality of components (the bottom member 30 and the tire support 31 including the support members 32, 34, and the loading members 36, 38), the cross member 28 may be formed as a wall that extends continuously between the first 24 and second 26 side members.

Referring to FIGS. 2 through 4, the tailgate assembly 22 further includes a carrier, generally indicated at 40, extending out from the plane 29 inwardly over the truck bed 16. More specifically, the carrier 40 is fixedly secured to each of the first 24 and second 26 side members and the cross member 28, and extends out at an angle with respect to each of these elements. The carrier 40 extends over the truck bed 16 and retains a tire 42, which is a wheel and tire combination well-known to those of ordinary skill in the art, in place over the truck bed 16 adjacent the back edge 25 thereof. Typically, the tire 42 will be a spare tire for use when needed. Preferably, the carrier 40 is sized to be able to carry any sized spare tire 42 and projects at an angle such that a majority of the truck bed 16 remains available for payload.

The carrier 40 includes a main structural bar 44 extending between the first 24 and second 26 side members. The main structural bar 44 includes a central arcuate segment 46 and outer segments 48, 50 extending out therefrom. The outer segments 48, 50 terminate at the respective first 24 and second 26 side members.

The carrier 40 also includes a plurality of support bars 52 each extending out from the bottom member 30 into the truck bed 16 and terminating at the main structural bar 44. Because the bottom member 30 is positioned below the truck bed 16, the plurality of support bars 52 is bent forward to avoid contacting the back edge 25 of the truck bed 16. A plate 54 is fixedly secured to at least a portion of the plurality of support bars 52. The plate 54 includes a threaded bore 56. The threaded bore 56 receives a fastener 58 therethrough in order to mount the spare tire 42 in place along the plate 54 of the carrier 40. Thus, when the spare tire 42 is mounted to the carrier 40, the spare tire 42 is supported by the plate 54, the plurality of support bars 52, and the main structural bar 44.

Although the carrier 40 has been described above and shown in the Figures as having a specific configuration, it is appreciated that the carrier 40 may have any of various shapes and configurations for receiving and retaining the spare tire 42 along the tailgate assembly 22.

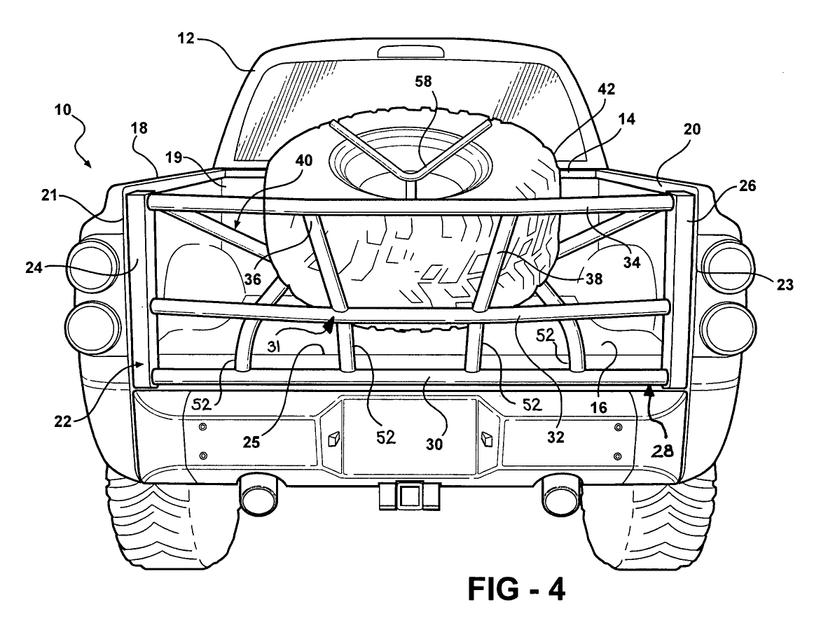

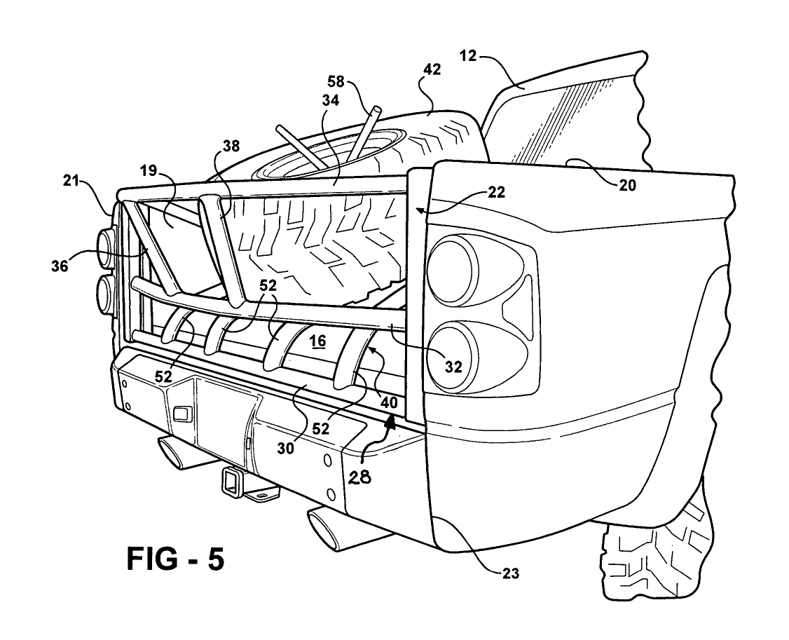

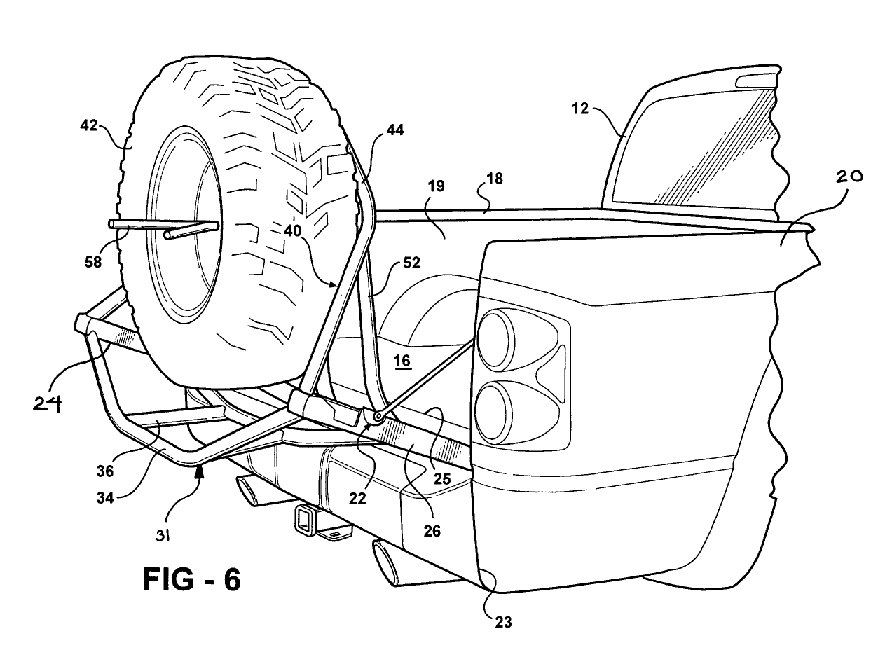

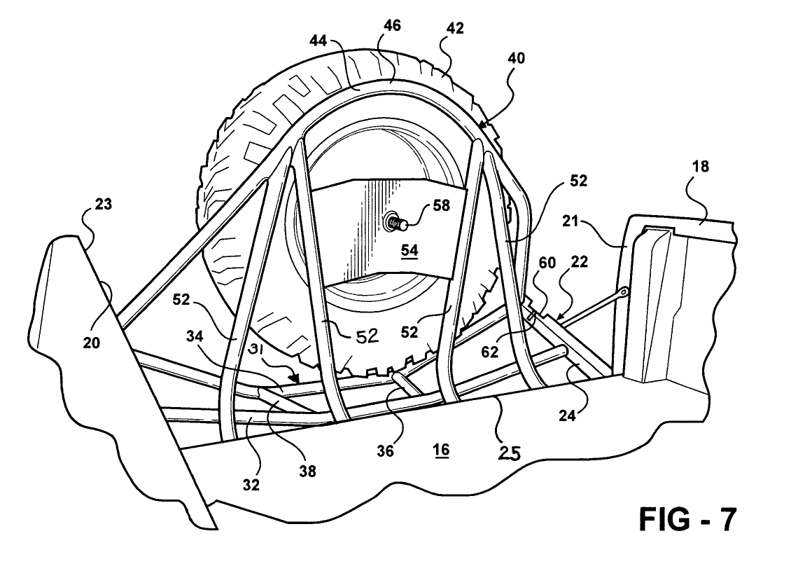

The tailgate assembly 22 is movable between a closed position, shown in FIGS. 4 and 5, and an open position, shown in FIGS. 6 and 7. In the closed position, the spare tire 42 is secured to the carrier 40 and is disposed over a portion of the truck bed 16. As mentioned above, although the spare tire 42 is retained over a portion of the truck bed 16 when the tailgate assembly 22 is in the closed position, a majority of the truck bed 16 may still be utilized for payload. A latch mechanism 60, shown in FIG. 7, is disposed along each of the side members 24, 26 to lock the tailgate assembly 22 in the closed position. The latch mechanism 60 is released by pressing down on a pin 62. In the open position, the spare tire 42 is rotated to a position disposed generally away from the truck bed 16 at approximately the chest height of an average user, thereby ensuring easy access to the spare tire 42.

In order to remove the spare tire 42, the user manually pivots the tailgate assembly 22 from the closed position to the open position. In the open position, the user can easily unscrew the fastener 58 and then pull the spare tire 42 off of the carrier 40. As the user removes the spare tire 42 while the tailgate assembly 22 is in the open position, the tire support 31 provides an intermediate resting surface for the spare tire 42 between the carrier 40 and the ground. This intermediate resting surface provided by the tire support 31 can also be used during mounting of the spare tire 42 to the carrier 40.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A tailgate assembly disposed between spaced apart first and second sides of a truck bed for retaining a tire, said tailgate assembly comprising:
a cross member extending between and pivotally coupled to the first and second sides of the truck bed to create a barrier therefor; and
a carrier fixedly secured to and extending out from said cross member for retaining the tire over a portion of the truck bed.

2. A tailgate assembly as set forth in claim 1 wherein said carrier includes a plurality of support bars fixedly secured to a portion of said cross member for supporting the tire.

3. A tailgate assembly as set forth in claim 2 wherein said carrier includes a plate fixedly secured to at least a portion of said plurality of support bars for mounting the tire along said carrier.

4. A tailgate assembly as set forth in claim 3 wherein said carrier includes a main structural bar fixedly secured between a portion of said cross member and said plurality of support bars for rigidly supporting said carrier.

5. A tailgate assembly as set forth in claim 4 wherein said cross member includes at least one support member disposed between the first and second sides of the truck bed and extending out away from said carrier.

6. A tailgate assembly as set forth in claim 5 wherein said cross member includes at least one loading member extending transverse to said at least one support member for supporting the tire as the tire is mounted to and removed from said carrier.

7. A tailgate assembly as set forth in claim 6 wherein said plate includes a mounting bore extending therethrough.

8. A tailgate assembly as set forth in claim 7 including a fastener received within said mounting bore for fixedly securing the tire to said carrier.

9. A tailgate assembly as set forth in claim 1 wherein said carrier extends out from said cross member at an acute angle to said first and second side members.

10. A tailgate assembly extending between first and second sides of a truck bed for retaining a tire, said tailgate assembly comprising:
a first side member disposed adjacent to and pivotally secured to the first side of the truck bed;
a second side member disposed adjacent to and pivotally secured to the second side of the truck bed;
a cross member fixedly secured to each of said first and second side members to create a barrier for the truck bed; and
a carrier extending out from said cross member for retaining the tire over a portion of the truck bed.

11. A tailgate assembly as set forth in claim 10 wherein said cross member includes at least one support member disposed between the first and second sides of the truck bed and extending out away from said carrier.

12. A tailgate assembly as set forth in claim 11 wherein said cross member includes at least one loading member extending transverse to said at least one support member for supporting the tire as the tire is mounted to and removed from said carrier.

13. A tailgate assembly as set forth in claim 12 wherein said carrier includes a plurality of support bars fixedly secured to a portion of said cross member for supporting the tire.

14. A tailgate assembly as set forth in claim 13 wherein said carrier includes a plate fixedly secured to at least a portion of said plurality of support bars for mounting the tire along said tailgate assembly.

15. A tailgate assembly as set forth in claim 14 wherein said carrier includes a main structural bar fixedly secured between a portion of said cross member and said plurality of support bars for rigidly supporting said carrier.

16. A tailgate assembly extending between first and second sides of a truck bed for retaining a tire, said tailgate assembly comprising:
a cross member extending between and pivotally coupled to each of the first and second sides of the truck bed for moving said tailgate assembly between a closed position and an open position;
a carrier extending out from said cross member for receiving the tire and retaining the tire over the truck bed when said tailgate assembly is in the closed position; and
a tire support extending out from said cross member away from said carrier for supporting the tire as the tire is mounted to and released from said carrier when said tailgate assembly is in the open position.

17. A tailgate assembly as set forth in claim 16 wherein said carrier includes a plurality of support bars fixedly secured to a portion of said cross member for supporting the tire therealong.

18. A tailgate assembly as set forth in claim 17 wherein said carrier includes a plate fixedly secured to at least a portion of said plurality of support bars for mounting the tire along said tailgate assembly.

19. A tailgate assembly as set forth in claim 18 wherein said carrier includes a main structural bar fixedly secured between said a portion of said cross member and said plurality of support bars for rigidly supporting said carrier.
